(19) United States
(12) Patent Application Publication
(10) Pub. No.: US 2019/0368633 A1
(43) Pub. Date: Dec. 5, 2019

(54) INTERNALLY HEATED VALVES

(71) Applicant: ITT MANUFACTURING ENTERPRISES LLC, Wilmington, DE (US)

(72) Inventors: A. David Sandiford, Lake Hughes, CA (US); Andrew Vasquez, Valencia, CA (US)

(21) Appl. No.: 15/992,981

(22) Filed: May 30, 2018

(51) Int. Cl. F16K 49/00; F16K 5/06

(52) U.S. Cl. CPC F16K 49/002; F16K 5/0663

(57) ABSTRACT

Various internally heated valves are disclosed. The internally heated valve can include a heater sleeve within a valve body. The heater sleeve can be electrically heated. The heater sleeve can heat fluid passing through the valve body.

### BACKGROUND

### Field

The disclosure generally relates to valves, such as ball valves, and improvements thereof.

### Description of Certain Related Art

Valves are used to direct and constrain the flow of fluids through lines (such as hoses, tubes, or other connecting vessels) and have a variety of applications. In some applications, valves are subjected to low temperatures. For example, in certain aircraft, certain valves that regulate the flow of potable water are not located within the pressure vessel of the aircraft and are subjected to low environmental temperatures at high altitudes. Water within the valves and lines can easily freeze.

### SUMMARY OF CERTAIN FEATURES

Freezing of fluid in the lines connecting to the valve can be addressed with the use of hose heaters, such as electrically resistive heaters that are wrapped around the line. However, hose heaters are limited to heating the line itself. As such, freezing in the valve continues to be a problem. For example, if the valve connecting one or more lines is closed, there is no circulation of warmed water (e.g., from heat provided by the hose heater) through the valve. As a result, water within the valve can freeze. This can lock-up the valve thereby rendering it inoperable. Moreover, freezing water inside the valve can cause damage and/or leakage. One solution to this problem is to add an external heater and/or insulation to the outer periphery of each valve assembly. While relatively simple, there are many drawbacks to externally heated and/or insulated valve assemblies. For example, due to the shape of most valves, it is difficult to position heating elements in contact with sufficient surface area of the valve. This results in inefficient heat transfer into the valve. In many cases, the heating elements heat air around the valve instead of heating the valve components or water within the valve directly through conduction.

An externally heated and/or insulated valve assembly is often double or triple the size of the valve. This is problematic for certain valve applications, such as aircraft, where the size of the valve can be limited. The externally heated and/or insulated valve assembly may also need to incorporate gaps or other connection features in order to connect with other components, such as linkages to control the valve actuation.

Some valves are hybrids designs with large sections of plastic material surrounding small actuation sections of corrosion resistant stainless steel (CRES) or other metals. The insulative properties of the plastic can exacerbate the difficulty in heating the actuation sections of the valve and the water in the valve. Thus, additional power and higher static temperatures are required to heat the valve and the water within the valve.

Another concern for a valve assembly for water systems in aircraft is the material requirements. Regulations for potable water systems are published in Air Transport Association of America (ATA) 100, Part 38 (“Water/Waste”). The requirements for potable water include provisions to prevent the water from contacting materials that can impart a taste, add lead to the water, or promote bacteria or fungus growth. This restricts the acceptable materials and adhesives that can be used in the valves and lines of the potable water systems in an aircraft.

A challenge for an internally heated valve is sealing of the heater within the valve. The fluid in the valve is under pressure and will always try to work itself to a lower pressure area, creating leakage. The material of the heater assembly and the valve body should therefore be amenable to sealing together. Any sealant or adhesive used to bond the ball valve assembly together should be both non-nutritive for mold or bacteria and acceptable for potable water systems (e.g., does not impart any taste into the water). Moreover, the dimensions of the heater assembly (e.g., thickness, length, or other) should be repeatable from a manufacturing perspective.

The present disclosure is directed to internally heated valves that address one or more of the problems noted above, or other problems. In some embodiments, the valve comprises an internally heated ball valve. The valve can include a forward threaded connection and an aft threaded connection. The valve can include central valve body that includes a ball, a retainer, and a heater. The heater can be positioned radially outside the ball and/or can form a sleeve. The heater can be spaced apart from the ball by the retainer. The heater can be configured to heat fluid passing through the ball valve, such as indirectly via conduction through the central valve body or the retainer. The valve can be electrically heated, such as with an electrical resistance heater.

In some embodiments, an internally heated ball valve for heating a fluid includes a fore end cap, an aft end cap, and a valve body. The fore and aft end caps couple with the valve body, such as on opposite sides thereof. A heater sleeve is configured to be electrically heated. A bore extends through the valve body and the heater sleeve is disposed within the bore. A ball with an orifice disposed therein is assembled within the heater sleeve. A first ball seat and a second ball seat are positioned on opposite sides of the ball within the heater sleeve. The ball is spaced away from the sleeve by the first and second ball seats. The heater sleeve heats fluid within the orifice via conduction through the ball. In certain implementations, the heater sleeve heats fluid within a space formed between an outer surface of the ball and an inner surface of the heater sleeve, which may be a place in which some of the fluid can become trapped.

In certain embodiments, a wire assembly has a conductor, such as a wire, extending through an aperture in an outer wall of the valve body. The wire couples with the heater sleeve for electrically coupling the heater sleeve with a power source.

In certain embodiments, an outer rim of the first ball seat has a channel with a gasket, such as an O-ring disposed therein. The O-ring sealingly engages with the heater sleeve. The wire couples on an outer end of the heater sleeve. The O-ring is disposed closer to the ball than the wire.

In certain embodiments, the heater sleeve is a cylindrical sleeve. In certain embodiments, the cylindrical sleeve has a slit for adjusting a diameter of the cylindrical sleeve during assembly within the through hole. In certain embodiments, the cylindrical sleeve has a seam connecting opposite ends of the cylindrical sleeve.

In certain embodiments, the valve includes a valve stem. The heater sleeve has an upper aperture for providing access through the heater sleeve to the ball. The valve stem is insertable within the upper aperture and couples with the ball to rotate the ball to actuate the valve between open and closed positions.

According to some implementations, an internally heated valve assembly includes a valve body having a bore extending therethrough. A heater sleeve can be located within the bore and the heater sleeve is configured to be electrically heated. A wire assembly electrically couples the heater sleeve with a power source. The wire assembly has a wire extending through an aperture in an outer wall of the valve body into the bore. The wire can extend through the aperture and couple with the heater sleeve.

In certain embodiments, a ball is assembled within the heater sleeve and first and second ball seats are assembled on opposite sides of the ball. The ball is spaced from the heater sleeve. In certain embodiments, the valve assembly includes a valve stem. The heater sleeve has an upper aperture for providing access through the heater sleeve to the ball. The valve stem inserts within the upper aperture and rotates the ball to actuate the valve between open and closed positions.

According to some embodiments, the heater sleeve has at least one dielectric layer. In certain embodiments, the heater sleeve has a chemically etched layer of resistant metal. In certain embodiments, the heater sleeve has a seam coupling together opposite ends of the heater sleeve. In certain embodiments, the heater sleeve has a CRES coating. In certain embodiments, a thickness of the heater sleeve is between about 0.001 inches and about 0.004 inches.

In some variants, an internally heated valve assembly has a valve body having a bore. A cylindrical heater sleeve assembles within the bore. The heater sleeve is electrically heated. A ball is assembled within the cylindrical heater sleeve and first and second ball seats are assembled on opposite sides of the ball.

In certain embodiments, a wire assembly electrically couples the cylindrical heater sleeve with a power source. The wire assembly has a wire extending through an aperture in an outer wall of the valve body into the bore. The wire extends through the aperture and couples with the cylindrical heater sleeve.

In some implementations, the valve includes a valve stem. The cylindrical heater sleeve has an upper aperture for providing access through the heater sleeve to the ball. The valve stem extends through the upper aperture and couples with the ball.

In certain embodiments, the cylindrical heater sleeve has a slit and/or a seam. In certain embodiments, the cylindrical heater sleeve is adhered to an inner surface of the bore. In certain embodiments, the heater sleeve can include a heater circuit, optionally of a dielectric material. The heater circuit can be a chemically etched layer of a resistance metal. The chemically etched layer can be in the range of about 0.001 to about 0.004″ thick, depending on power required and voltage applied. In certain embodiments, the heater sleeve can include dielectric layers consisting of a flexible plastic. The flexible plastic can allow insertion of the heater sleeve into a valve body. Outer cover layers of the heater sleeve can be made from CRES. The CRES material can provide abrasion resistance for the heater sleeve and/or strengthen the heater sleeve in torsion and compression.

### BRIEF DESCRIPTION OF THE FIGURES

Various features of internally heated valves and methods disclosed herein are described below with reference to the drawings of certain embodiments. The illustrated embodiments are intended to illustrate, but not to limit the present disclosure.

FIG. 1 is a perspective view of a heated ball valve assembly.

FIG. 2 is a perspective view of a valve body of the assembly of FIG. 1.

FIG. 3 is a perspective view of a valve ball and seats of the assembly of FIG. 1.

FIG. 4 is a top view of a heater insert of the assembly of FIG. 1.

FIG. 5 is an end view of the heater insert of FIG. 4.

FIG. 6 is an exploded view of the assembly of FIG. 1.

FIG. 7 is a side elevation view of the assembly of FIG. 1.

FIG. 8 is an end view of the assembly of FIG. 1.

FIG. 9 is a section view taken along the line 9-9 in FIG. 8.

FIG. 10 is a detailed view of FIG. 9.

### DETAILED DESCRIPTION OF CERTAIN EMBODIMENTS

Various embodiments of internally heated valves and related methods are disclosed. Certain embodiments of the valves are disclosed in the context of a valve for controlling fluid flow in an aircraft, as the valves have present disclosure particular utility in that context. However, the various aspects of the present disclosure can be used in many other contexts as well. None of the features described herein are essential or indispensable. Any feature, structure, or step disclosed herein can be replaced with or combined with any other feature, structure, or step disclosed herein, or omitted.

### Overview

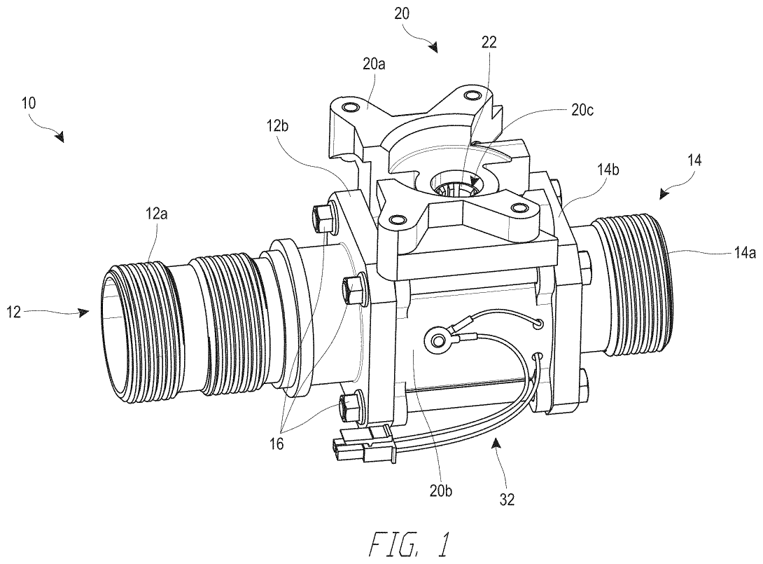

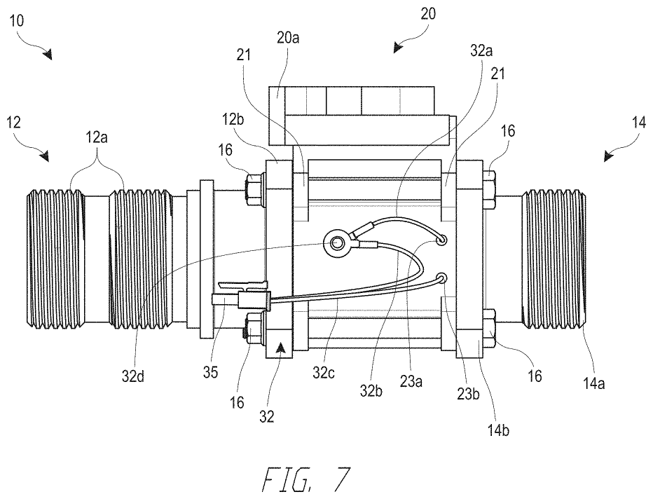

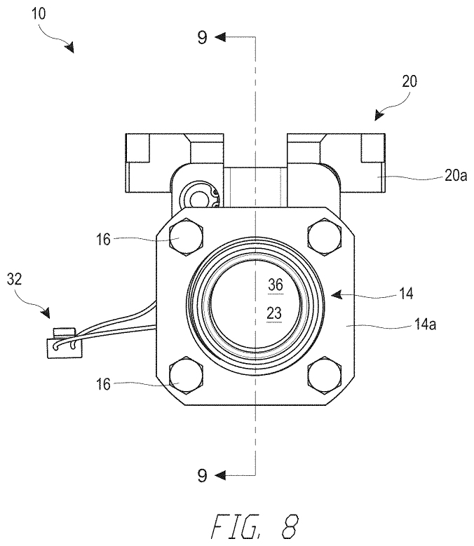

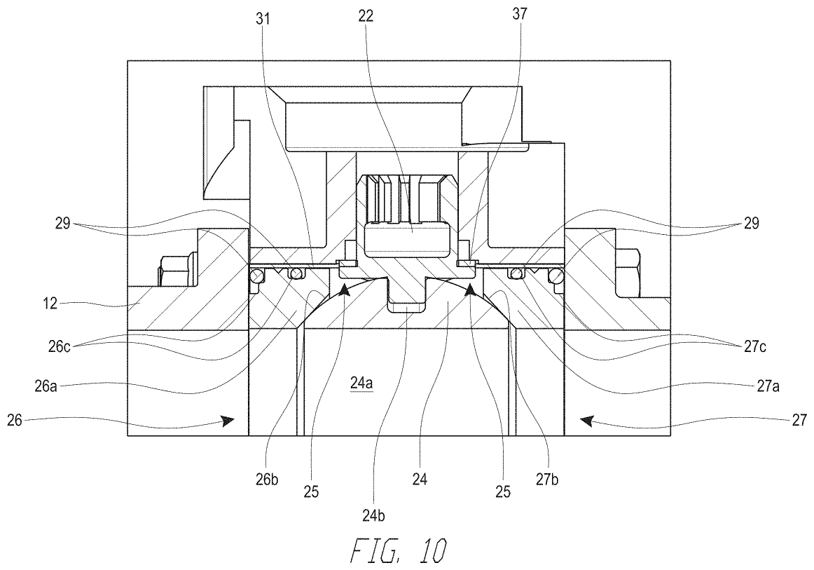

FIGS. 1-10 illustrate a heated valve assembly 10 and components thereof. The valve 10 can be used in conjunction with a fluid transfer system. The fluid transfer system can include one or more lines (e.g., pipes) that can be used to deliver one or more fluids (e.g., potable water, waste water, or other fluid) through the one or more lines. The valve 10 can be used to regulate the delivery of the fluid through the one or more lines. The valve 10 and fluid transfer system can be applied in numerous applications. For example, the valve 10 and fluid transfer system can used within an aircraft to carry various fluids between locations on the aircraft (e.g., between a storage tank and a lavatory). Heating of the valve 10 can inhibit and/or prevent fluid in the valve 10 from freezing, which can damage the valve components. However, the valve 10 is not limited to use in an aircraft and can be used in other contexts, such as on a recreational vehicle, in a residential or commercial outdoor plumbing system, or otherwise. Moreover, although disclosed in the context of a ball valve, the technology described herein are not limited to ball valves. For example, in some variants, the valve comprises a butterfly valve, diaphragm valve, gate valve, globe valve, or otherwise.

The valve 10 can include a fore end cap 12 and/or an aft end cap 14. The fore end cap 12 can connect with one portion of the fluid transfer system. For example, the fore end cap 12 can connect with a line, such as a flexible or rigid hose. A fluid pathway can extend through the fore end cap 12. The fore end cap 12 can include a plurality of threaded connections 12a for assembling with corresponding lines in the fluid transfer system. The fore end cap 12 can be generally round so that it connects in an easy and standardized connection with the fluid transfer system. The fore end cap 12 can include a flange 12b. The flange 12b can couple with a valve body 20. For example, the flange 12b can include a plurality of holes for receiving a mechanical fastener, for example, one or more nuts and bolts 16.

The aft end cap 14 can similarly connect with a line or hose of the fluid transfer system. The aft end cap 14 can be generally round and include a fluid pathway disposed therethrough for the transfer of fluid. The aft end cap 14 can include one or more threads 14a for connection to lines of the fluid transfer system. The aft end cap 14 can include a flange 14b for coupling with the valve body 20 (e.g., using a mechanical fastener).

The valve 10 can include the valve body 20. The valve body 20 can define a central structure of the valve 10. The fore end cap 12 and the aft end cap 14 can be assembled on opposite sides of the valve body 20. In some implementations, the fore end cap 12 and/or the aft end cap 14 can be assembled with the valve body 20 with the mechanical fastener or the nut and bolt assembly 16. In some implementations, the mechanical fastener can be a mechanical coupler, adhesive, or other mechanisms that attaches the fore end cap 12 and/or the aft end cap 14 with the valve body 20. In certain implementations, the fore end cap 12 and/or the aft end cap 14 are formed integrally with valve body 20. As illustrated and described herein, the valve 10 is a split body valve. However, the valve 10 can be implemented as a single body, three-piece body, top entry, end entry, welded, or any other type of valve construction.

The valve body 20 can include an upper portion 20a and a lower portion 20b. The upper portion 20a can include a recess or aperture 20c through which a valve stem 22 can extend to actuate a ball 24 of the valve 10, as described further below. The valve stem 22 can couple with a motor or other actuator for moving the valve 10 between open and closed positions. The open position allows the flow of fluid through the valve 10. The closed position inhibits or prevents the flow of fluid through the valve 10. In some implementations, the valve 10 can be actuated to a partially open position, as described further below.

A wiring assembly 32 can provide power to an internal heater sleeve 30. The heater sleeve 30 can heat the valve 10, thereby inhibiting or preventing the fluid from freezing and the valve 10 from locking up. The heater sleeve 30 can be assembled within the valve body 20, as described further below.

### Valve Body

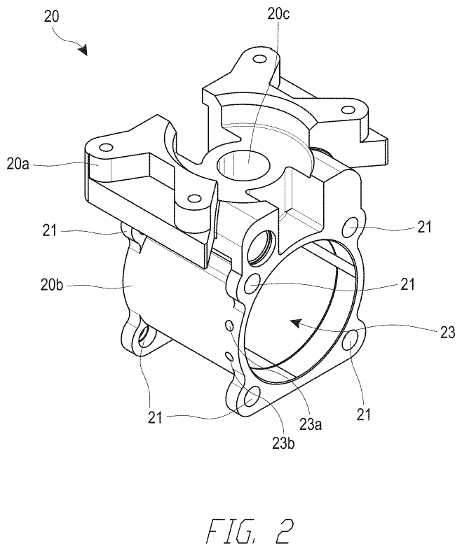

FIG. 2 illustrates the valve body 20. The valve body 20 can include a central bore 23. An outer wall of the lower portion 20b can define the bore 23. The bore 23 can be generally cylindrically shaped. In some implementations, the bore 23 can include cylindrical portions and non-cylindrical portions, such as to accommodate other internal components of the valve 10. The bore 23 can include a diameter sized to accommodate the ball 24 and the heater sleeve 30 therein.

The lower portion 20b can include one or more corresponding slots 21. The nut and bolt assemblies 16 can be inserted through the corresponding slots 21. The corresponding slots 21 can be used to assemble the fore and aft end caps 12, 14 on opposite sides of the valve body 20. In one implementation, the lower portion 20b includes four slots 21 on one side corresponding to four slots 21 on the opposite side. The bore 23 can extend therebetween. While described as being a part of the lower portion 20b, the corresponding slots 21, or other attachment mechanisms for the end caps can be located anywhere on the valve body 20.

The lower portion 20b can include one or more apertures 23a, 23b. The one or more apertures 23a, 23b can provide access to the bore 23 through an outer wall of the lower portion 20b. For example, the one or more apertures 23a, 23b can provide access to the heater sleeve 30. One or more conductors (e.g., wires) of the wiring assembly 32 can extend through the one or more apertures 23a, 23b. The one or more conductors can be electrically coupled with the heater sleeve 30 to provide power thereto. The diameters and number of apertures 23a, 23b can be minimized to reduce the total outward pressure on the heater sleeve 30 (e.g., pressure from the fluid).

### Ball and Seats

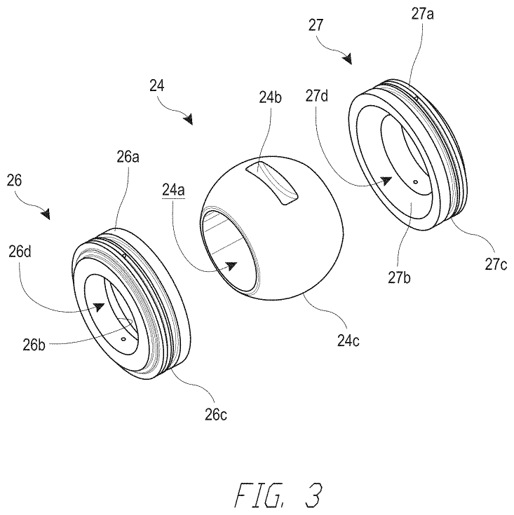

In certain embodiments, the valve 10 includes the ball 24 and first and second ball seats 26, 27, such as illustrated in FIG. 3. The ball 24 can include an orifice 24a. The orifice 24a can accommodate fluid flow through the ball 24 in the open position of the valve 10. The ball 24 can include a keyhole or slot 24b. The keyhole or slot 24b can couple with the valve stem 22. The valve stem 22, in turn, can be coupled with a motor or actuator for turning the ball 24 to allow, block or partially block the flow of fluid through the orifice 24a. In some implementations, the valve stem 22 is fixedly coupled with the ball 24.

The first ball seat 26 can include an outer rim 26a. The outer rim 26a can include one or more grooves 26c. The grooves 26c can receive one or more gaskets (e.g., O-rings). The gaskets can provide the sealing engagement between the first ball seat 26 and the heater sleeve 30 and/or the valve body 20. The seat 26b can engage with an outer spherical surface 24c of the ball 24. The outer spherical surface 24c can be in sliding (e.g., rotationally) engagement with the seat 26b. The seat 26b can be chamfered, curved, or any other suitable profile. A through passage 26d can extend through the first ball seat 26.

The second ball seat 27 can include an outer rim 27a. A through passage 27d can extend through the second ball seat 27. The outer rim 27a can include one or more grooves 27c. The grooves 27c can receive one or more gaskets, such as O-rings, to enhance the sealing engagement between the second ball seat 27 and the heater sleeve 30 and/or the valve body 20. A seat 27b can engage with the outer spherical surface 24c of the ball 24. The outer spherical surface 24c can rotate with sliding engagement with the seat 27b.

In various embodiments, the seats 26b, 27b are configured to facilitate rotation of the ball 24 within the valve body 20, such as between the open and closed positions of the valve 10. The seats 26b, 27b can maintain a seal (e.g., a fluid-tight seal) between the seats 26b, 27b and the outer spherical surface 24c where the outer spherical surface 24c contacts the valve seats 26b, 27b.

In the open position, the orifice 24a can be aligned or at least partially aligned with the bore 23 of the valve body 20 so that a fluid flow can pass through the valve 10. The ball 24a can inhibit or prevent fluid flow in the closed position of the valve 10. In some embodiments, the ball 24 is rotated approximately 90 degrees from the open position to the closed position. When turned, the misalignment of the bore 23 and the orifice 24a block or partially block the flow of fluid. The ball 24 can partially block the flow of fluids through the valve 10 between the open and closed positions.

In some embodiments, the valve 10 can be a full bore valve. Full bore indicates that the orifice 24a has a diameter at least equal to the diameter of the lines of the fluid transfer system. In some embodiments, the valve 10 can be a reduced bore valve in which the orifice 24a has a diameter smaller than the diameter of the lines of the fluid transfer system. In some variants, the valve 10 comprises a v-port valve in which the orifice 24a has a V-shape. Other shapes for the orifice 24a are contemplated as well. The ball 24 can be rotated between the open and closed positions about an axis extending through the valve stem. In some embodiments, the valve 10 comprises a free floating ball valve, in which the ball 24 is supported by the first and second ball seats 26, 27 and/or the valve stem. In some implementations, the valve 10 can include trunnions to support and/or stabilize rotation of the ball 24 (e.g., between the open and closed positions).

### Heater Sleeve

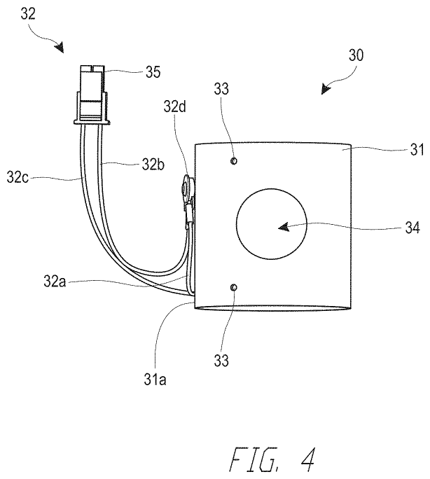

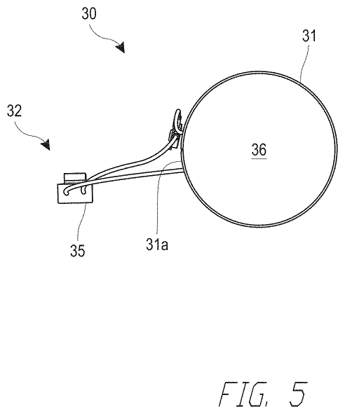

FIGS. 4 and 5 illustrate the heater sleeve 30. The heater sleeve 30 can include a sleeve 31. The sleeve 31 can include an aperture 34. The aperture 34 can provide access to the ball 24 for the valve stem. The valve stem can extend through the aperture 34. The sleeve 31 can define a through passage 36. The sleeve 31 can fit within the bore 23 of the valve body 20. For example, the sleeve 31 can fit generally flush with an interior wall of the bore 23. In some implementations, the sleeve 31 can be connected to (e.g., adhered with an adhesive) the interior wall of the bore 23.

The sleeve 31 can be made out of any suitable material. The sleeve 31 can be formed of etched foil, ribbon, wire, film, or other suitable materials. In some implementations, the sleeve 31 can comprise one or more layers. One or more of the layers can be a dielectric layer, which can comprise a flexible plastic to allow insertion into the valve body. One or more of the layers can comprise a metal, such as CRES. The sleeve 31 can include CRES layers, CRES substrate and/or a CRES coating. The CRES material provide abrasion resistance of the heater and/or strengthen the heater assembly in torsion and/or compression. The sleeve 31 can be chemically etched to provide additional resistance pathways for electricity. Such resistance pathways can be used to generate and/or increase heat within the sleeve 31. In some implementations, the sleeve 31 can be at least about 0.001″ and/or less than or equal to about 0.004″ thick. In various embodiments, the sleeve 31 has a longitudinal length that is greater than its thickness, such as at least ten times greater. In certain embodiments, the sleeve 31 is not shaped as a ring, or as a torus with a circular or rectangular cross section.

In some embodiments, the sleeve 31 is formed from a flat sheet that is rolled into a tubular form. As a result, the sleeve 31 can include a slit or a seam 31a. The seam 31a can be formed by opposite ends of the sleeve 31 having joined together. The slit can be closed by being brazed, welded, soldered, adhered or using another joining technique. In some embodiments, the slit 31a is not closed, which can allow the diameter of the sleeve 31 to vary. The sleeve 31 can form a cylindrical shape. The diameter of the sleeve 31 can generally correspond to the diameter of the bore 23 of the valve body 20. For example, the sleeve 31 can be smaller than the diameter of the valve bore 23 so that the sleeve 31 can be tightly received in the bore 23. In some implementations, the bore 23 of the valve body 20 and/or the sleeve 31 do not precisely match, which can leave one or more spaces between the sleeve 31 and the valve body 20. The sleeve 31 need not be perfectly cylindrical. For example, the sleeve 31 can be oval, polygonal, or other shape in cross-section, or have a non-uniform cross-section. In some implementations, the heater assembly is formed to the shape of the valve body 20 interior.

The sleeve 31 can be inserted within the bore 23. The slit of seam 31a can allow for the diameter of the sleeve 31 to be adjusted to facilitate insertion into the bore 23. An adhesive can be used to connect the sleeve 31 within the valve body 20. The adhesive used to bond the sleeve 31 to the valve body 20, and/or to bond the seam 31a together, can be non-nutritive for mold or bacteria and otherwise acceptable for potable water systems (e.g., the adhesive does not impart any taste into the water).

The heater sleeve 30 can include the wire harness 32. The wire harness 32 can electrically connect the heater sleeve 30 with a power source (not shown). The wire harness 32 can include a plurality of conductors, such as first, second, and/or third wires 32a, 32b, 32c. A connector 35 can couple (e.g., directly or indirectly) the wires with the power source. In some implementations, the wire harness 32 does not include the connector 35, such as the wires (comprising bare pigtails or insulated wires only).

The wires 32a, 32c of the wire harness 32 can be attached directly with the sleeve 31 (e.g., soldered or mechanically fastened with one or more of the materials of the sleeve 31). For example, the wires 32a, 32c can be attached to an outer surface of the sleeve 31. In some implementations, the wires 32a, 32c can be extended fully or partially through the sleeve 31 and couple with an interior layer of the sleeve 31. This can facilitate the assembly of the heater sleeve 30 within the bore 23 (e.g., by not adding the size of the wires 32a, 32c to the outer diameter of the sleeve 31).

The wires 32a and/or 32c can pass through the apertures 23a, 23b when the heater sleeve 30 is installed within the bore 23 of the valve body 20. In some implementations, the wires 32a and/or 32c are electrically coupled with the heater sleeve 30 when the heater sleeve 30 is installed within the bore 23 (e.g., through the apertures 23a, 23b). In certain implementations, the heater sleeve 30 is inserted within the bore 23 with the wires 32a and/or 32c already coupled, and the wires 32a and/or 32c are extended out of the bore 23 through the apertures 23a, 23b during assembly. The slit 31a in the sleeve 31 can allow for the sleeve 31 to be radially compressed or expanded to fit in the bore 23 and/or to aid in orienting the wires 32a, 32c with the 23a, 23b. In some implementations, the wires 32a, 32c have a restricted angle of exit from the apertures 23a, 23b, which can reduce the chance of damage to the wires 32a, 32c, which could cause grounding out against the valve body. In some embodiments, the wires 32a, 32c can be potted to inhibit or prevent grounding and/or dielectric failure.

In some implementations, one or more of the apertures 23a, 23b are positioned toward an outer end of the sleeve 31. The apertures 23a, 23b can be located outside of the gasket 29). This arrangement inhibits or prevents fluid in the valve 10 from accessing the apertures 23a, 23b. This can reduce the amount of outward pressure from the fluid on areas of the sleeve 31 corresponding to the apertures 23a, 23b and/or coupled with the wires 32a, 32c. Maintaining apertures 23a, 23b apart from the fluid can reduce the chance of leakage through the connections of the wires 32a, 32c with the sleeve 31.

In some implementations, the wire harness 32 can include a sensor 32d. For example, the sensor 32d can be a thermal control sensor, solid state sensor, chemical thermostat, or other type of sensor or controller. In some implementations, the sensor 32d is a relay control box for monitoring current and/or temperature or other properties of the heater system 30. In some implementations the sensor 32d can be potted and/or include a thermoset dielectric material that can inhibit or prevent damage to the sensor (e.g., by transfer of excessive heat or moisture into the sensor). In some embodiments, overheat sensors can be included within the heater sleeve 30, the wiring assembly 32, or otherwise within the valve 10 to increase user safety. For example, the overheat sensor can indicate that the valve 10 and/or fluid (e.g., water) are near or at or above can upper temperature limit. This can trigger an alarm to alert of the overheat situation.

The sleeve 31 can also include one or more apertures 33. The apertures 33 can be used to accommodate wires, sensors or pressure flow paths through the sleeve 31 and into the through passage 36. For example, the valve 10 can include a flow path through the one or more apertures 33 to a pressure relief valve that allows a pressure release across one or both sides of the valve 10. In some embodiments, the pressure relief valve allows fluid to bypass and/or flow outside of the ball 24.

### Operational Characteristics

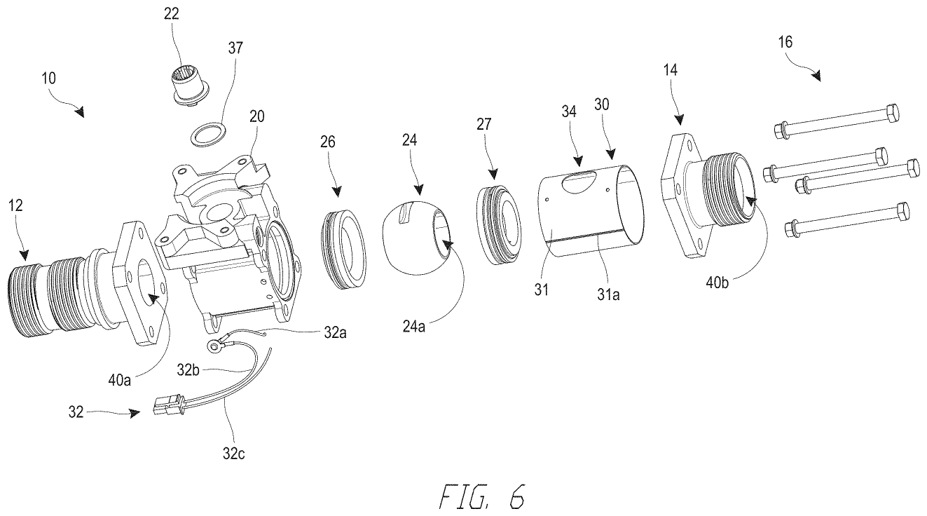

FIGS. 6-10 illustrate certain internal and external components of the valve 10. The nut and bolt assemblies 16 can extend through the holes of the flanges 12b, 12a to connect the fore and aft end cap 12, 14 with the valve body 20. The nut and bolt assemblies 16 can extend through the receiving holes 21 of the valve body 20. The nut and bolt assemblies 16 can be tightened to secure together the valve assembly 10. In some implementations, one or more gaskets (not shown) can be included between the valve body 20 and each of the fore and aft end caps 12, 14.

The upper portion 20a can include one or more flanges for coupling with a motor, actuator, or other mechanisms for controlling the valve 10, such as for opening and closing the valve 10 to allow or block fluid flow with the valve stem 22. The upper portion 20a can include the aperture 20c. The aperture 20c can provide access to the ball 24 through the aperture 34. The aperture 20c can be centered along a central axis of the bore 23. The valve stem 22 can be received within the valve body 20, such as in the aperture 20c. The valve stem 22 can couple with the ball 24 (e.g., at the slot 24b). The valve stem 22 can be coupled with the motor. For example, the valve stem 22 can include a recess that receives a drive shaft of the motor. The valve stem 22 can actuate the ball 24 between the open, closed, and/or partially closed positions. The valve stem 22 can include a gasket or washer 37. The gasket or washer 37 can reduce pressure and/or friction between the valve stem 22 and the valve body 20 and/or can inhibit or prevent fluid from exiting the valve 10 between the valve stem 22 and body 20.

The ball 24, the first ball seat 26, and/or the second ball seat 27 can be assembled within the through passage 36 of the heater sleeve 30. The ball 24 can be assembled between the first and second ball seats 26, 27. The heater sleeve 30 (including the first and second ball seats 26, 27 and the ball 24) can be assembled within the bore 23 of valve body 20, either as a unit or individually. In some embodiments, an inner surface of the bore 23 can include one or more grooves (not shown). The grooves can receive one or more O-rings or other gaskets that can sealingly engage with the heater sleeve 30.

The ball 24 can be installed within the through passage 36 of the heater sleeve 30. The slot 24b can be aligned with the aperture 34 of the sleeve 31. The first and second ball seats 26, 27 can be received in the passage 36 on either side of the ball 24. The ball 24 can be positioned in a central location within the through passage 36. In certain variants, the ball 24 can be spaced from the inner wall of the sleeve 31). The ball seats 26b, 27b can slidingly engage with the ball 24. The outer rims 26a, 27a can fit within the heater sleeve 30. The first and second rims 26, 27 can position the ball 24 such that it does not contact and/or is offset from and/or is spaced apart from the sleeve 31.

The outer rims 26a, 27a can include the one or more grooves 26c, 27c. The grooves 26c, 27c can receive one or more O-rings 29. The O-rings 29 can sealingly engage with an inner surface of the sleeve 31. The sleeve 31 can be positioned so that it is not within the direct flow path of the fluid through the valve 10. The direct flow path of the fluid generally includes through passages 40a, 40b of the fore and aft end caps 12, 14, the through passages 26d, 27d, and the orifice 24a.

The orifice 24a of the ball 24 can be selectively aligned and offset (e.g., misaligned) with the through passages 26d, 27d of the first and second ball seats 26, 27, respectively. Alignment of the orifice 24a with the through passages can allow or partially allow fluid flow through the valve 10. The through passages 26d, 27d of the first and second ball seats 26, 27 can be aligned with through passages 40a, 40b extending through the fore and aft end caps 12, 14, respectively. This can allow for fluid to flow through the valve 10 and into the fluid transfer system, with the ball 24 in the open configuration. In the closed position, the fluid flow through the valve 10 and into the fluid transfer system is blocked. The position of the ball 24 can be modulated to provide varying amounts of fluid flow through the valve 10. The outer spherical surface 24c of the ball 24 can facilitate rotation of the ball 24 within the valve body 20.

In some embodiments, fluid passing through valve 10 can enter into a space 25 between the sleeve 31 (or valve body 20) and the outer spherical surface 24c of the ball 24. The space 25 can extend around a periphery of the ball 24. In some embodiments, the fluid can become trapped in the space 25. In some embodiments, fluid may become trapped inside the orifice 24a. For example, the fluid can become trapped in the orifice 24a in the partially aligned or closed positions of the ball 24. If the trapped fluid in such locations were to freeze the valve 10 could lock up, be damaged, and/or leak. For example, expansion of the fluid from freezing might cause deformation and failure of the valve body 20, valve stem 22, ball 24, ball seats 26, 27, sleeve 31, or other components of the valve 10.

In various embodiments, the valve 10 is configured to inhibit or prevent trapped fluid within the valve 10 from freezing. For example, the heater sleeve 30 can heat the valve 10 and the trapped fluid. This can prevent the trapped fluid, or other fluid within the valve 10, from freezing. For example, the valve 10 can inhibit or prevent the freezing of fluid within the through passages 40a, 40b, the space 25, the orifice 24a, the through passage 36, the bore 23, and/or other locations. The heater sleeve 30 can be connected with the electrical power source through the wire harness 32. The resistance of the material of the heater sleeve 30 can convert the electrical energy into thermal energy that warms the valve 10 (e.g., the ball 24 and/or the seats 26, 27) and/or the fluid therein. The heater sleeve 30 can be configured to be powered by an AC and/or DC power supply.

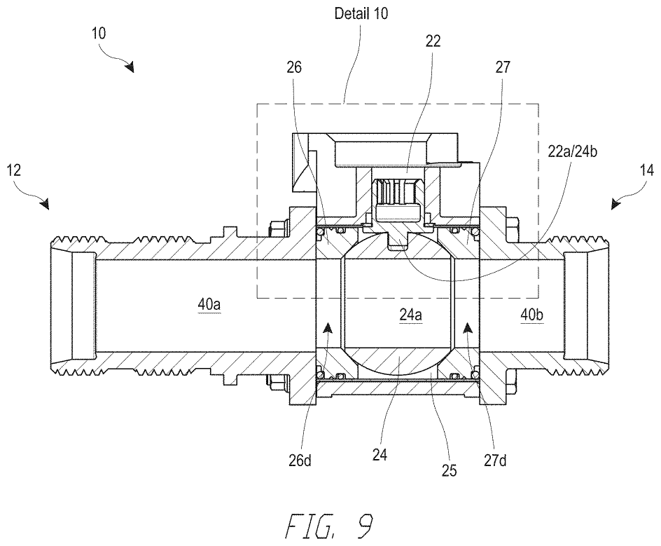

As shown in FIG. 9, the sleeve 31 can be substantially completely engaged with (e.g., cover) radially inwardly facing surfaces of the valve body 20. In some embodiments, the sleeve 31 is bonded to (e.g., with adhesives) to the valve body 20. This can enhance heat conduction to the valve body 20 and/or the ball seats 26, 27. In some implementations, the sleeve 31 is not in contact with and/or is radially spaced apart from the ball 24. This can reduce wear on the sleeve 31 by avoiding contact with movable components of the valve 10. As shown in FIG. 9, the sleeve 31 can be radially inward of and/or encased by the valve body 20. This can protect the sleeve 31 from damage. In several embodiments, the sleeve 31 is radially outward of the ball 24 and/or the seats 26, 27. As illustrated, the passage 36 of the sleeve 31 can receive the ball 24 and/or the seats 26, 27. For example, the entire of the longitudinal length of the ball 24 and/or the seats 26, 27 can be received in the sleeve 31. In various embodiments, the ball 24 and/or the seats 26, 27 are radially spaced apart from the valve body 20 by the sleeve 31. In some implementations, the ball 24 and/or the seats 26, 27 do not contact the valve body 20.

In various embodiments, the sleeve 31 extends longitudinally beyond the ball 24, such as is illustrated in FIG. 9. In some embodiments, the sleeve 31 extends longitudinally beyond seats 26, 27. As illustrated, in some variants, the longitudinal ends of the sleeve 31 and the seats 26, 27 are substantially aligned. In various implementations, the sleeve 31 provides a generally continuous cylinder of thermal energy to the seats 26, 27, the ball 24, fluid in the passages 26d, 27d, fluid in the orifice 24a, and/or fluid in the space 25. This can provide more robust and dependable heating compared to, for example, valves with annular heating elements.

The fluid within the valve 10 can be heated indirectly by the heater sleeve 30. For example, heat can be conducted from the heater sleeve 30 to the ball 24 and from the ball 24 to fluid within the orifice 24a and/or the passages 26d, 27d of the seats 26, 27. In certain embodiments, heat is transferred from the heater sleeve 30 to one or both of the seats 26, 27. Heat from one or both of the seats 26, 27 can be transferred through the ball 24 to fluid in the orifice 24a. Heat from one or both of the seats 26, 27 can be transferred to fluid in the passages 26d, 27d. In some implementations, the fluid within the inner space 25 is heated indirectly through the ball 24, the first or second ball seats 26, 27, the stem 22, or other component of the valve 10. In some embodiments, the fluid within the valve 10 can be heated directly by the heater sleeve 30. For example, in some implementations, fluid within the inner space 25 directly contacts the sleeve 31 and is heated thereby. Direct and indirect heating of the fluid can each inhibit or prevent the fluid from freezing. For example, when the valve is closed, fluid trapped within the orifice 24a can be heated by the heater sleeve 30, such as through the ball 24. The internal heating of the valve 10 can enable the valve 10 to withstand very low temperatures, such as those encountered at high altitudes of aircraft. In various embodiments, the heater sleeve 30 can increase the surface area contacting the fluid to be heated and/or other internal components of the valve assembly, thereby increasing heating efficiency.

### Certain Terminology

Terms of orientation used herein, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

### SUMMARY

Several illustrative embodiments of internally heated valves and associated methods have been disclosed. Although this disclosure has been described in terms of certain illustrative embodiments and uses, other embodiments and other uses, including embodiments and uses which do not provide all of the features and advantages set forth herein, are also within the scope of this disclosure. Components, elements, features, acts, or steps can be arranged or performed differently than described and components, elements, features, acts, or steps can be combined, merged, added, or left out in various embodiments. All possible combinations and subcombinations of elements and components described herein are intended to be included in this disclosure. No single feature or group of features is necessary or indispensable.

Certain features that are described in this disclosure in the context of separate implementations can also be implemented in combination in a single implementation. Conversely, various features that are described in the context of a single implementation also can be implemented in multiple implementations separately or in any suitable subcombination. Moreover, although features may be described above as acting in certain combinations, one or more features from a claimed combination can in some cases be excised from the combination, and the combination may be claimed as a subcombination or variation of a subcombination.

Any portion of any of the steps, processes, structures, and/or devices disclosed or illustrated in one embodiment or example in this disclosure can be combined or used with (or instead of) any other portion of any of the steps, processes, structures, and/or devices disclosed or illustrated in a different embodiment, flowchart, or example. The embodiments and examples described herein are not intended to be discrete and separate from each other. Combinations, variations, and other implementations of the disclosed features are within the scope of this disclosure.

While operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Additionally, the operations may be rearranged or reordered in other implementations. Also, the separation of various components in the implementations described above should not be understood as requiring such separation in all implementations, and it should be understood that the described components and systems can generally be integrated together in a single product or packaged into multiple products. Additionally, other implementations are within the scope of this disclosure.

Further, while illustrative embodiments have been described, any embodiments having equivalent elements, modifications, omissions, and/or combinations are also within the scope of this disclosure. Moreover, although certain aspects, advantages, and novel features are described herein, not necessarily all such advantages may be achieved in accordance with any particular embodiment. For example, some embodiments within the scope of this disclosure achieve one advantage, or a group of advantages, as taught herein without necessarily achieving other advantages taught or suggested herein. Further, some embodiments may achieve different advantages than those taught or suggested herein.

Some embodiments have been described in connection with the accompanying drawings. The figures are drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

For purposes of summarizing the disclosure, certain aspects, advantages and features of the inventions have been described herein. It is to be understood that not necessarily any or all such advantages are achieved in accordance with any particular embodiment of the inventions disclosed herein. No aspects of this disclosure are essential or indispensable. In many embodiments, the internally heated valve may be configured differently than illustrated in the figures or description herein. For example, various functionalities provided by the illustrated modules can be combined, rearranged, added, or deleted. In some embodiments, additional or different processors or modules may perform some or all of the functionalities described with reference to the example embodiment described and illustrated in the figures. Many implementation variations are possible. Any of the features, structures, steps, or processes disclosed in this specification can be included in any embodiment.

In summary, various embodiments and examples of internally heated valves and methods of installing and using the same have been disclosed. This disclosure extends beyond the specifically disclosed embodiments and examples to other alternative embodiments and/or other uses of the embodiments, as well as to certain modifications and equivalents thereof. Moreover, this disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims.

The following is claimed:

1. An internally heated ball valve for heating a fluid, the internally heated ball valve comprising:
a valve body comprising a bore;
a fore end cap coupled with a first end of the valve body;
an aft end cap coupled with a second end of the valve body;
a heater sleeve positioned in the bore of the valve body, the heater sleeve configured to be electrically heated, the heater sleeve comprising a through passage;
a ball comprising an orifice, the ball received in the through passage of the heater sleeve;
a first seat that is positioned on a first side of the ball and received in the through passage of the heater sleeve; and
a second seat that is positioned on a second side of the ball and is received in the through passage of the heater sleeve;
wherein the heater sleeve is configured to heat fluid within the orifice by transferring thermal energy to the ball.

2. The ball valve of claim 1, wherein the heater sleeve and the bore are of approximately equal length.

3. The ball valve of claim 1, wherein the heater sleeve comprises a cylindrical sleeve.

4. The ball valve of claim 3, wherein the cylindrical sleeve comprises a slit that allows adjustment of a diameter of the cylindrical sleeve.

5. The ball valve of claim 1, wherein the valve further comprises a space between a radially outer surface of the ball and a radially inner surface of the heater sleeve, and wherein the heater sleeve is configured to heat fluid in the space.

6. The ball valve of claim 1, wherein the heater sleeve is configured to heat fluid within the orifice indirectly, via conduction, by transferring thermal energy to the first and second seats, which transfer the thermal energy to ball.

7. The ball valve of claim 1, wherein the ball is spaced apart from the sleeve by the first and second ball seats.

8. The ball valve of claim 1, further comprising a conductor that extends through an aperture in an outer wall of the valve body, the conductor coupled with the heater sleeve for electrically coupling the heater sleeve with a power source.

9. The ball valve of claim 1, wherein an outer rim of the first ball seat comprises a channel with an O-ring, the O ring sealingly engaged with the heater sleeve.

10. The ball valve of claim 1, wherein the valve body further comprises a valve stem and the heater sleeve further comprises an aperture, the valve stem received through the aperture and engaged with the ball to enable actuation of the ball between open and closed positions.

11. An internally heated valve assembly comprising:
a valve body having a bore extending therethrough;
an electrically resistive heater sleeve within the bore; and
a wire assembly for electrically coupling the heater sleeve with a power source, the wire assembly comprising a conductor that extends through an aperture in an outer wall of the valve body into the bore and couples with the heater sleeve;
wherein the heater sleeve has a longitudinal length and a radial thickness, the longitudinal length being greater than the radial thickness.

12. The assembly of claim 11, wherein the longitudinal length is at least 10 times greater than the radial thickness.

13. The assembly of claim 11, further comprising a ball and first and second ball seats, the ball assembled within the heater sleeve and the first and second ball seats assembled on opposite sides of the ball, wherein the ball is spaced from the heater sleeve.

14. The assembly of claim 11, wherein the heater sleeve comprises at least one dielectric layer.

15. The assembly of claim 11, wherein the heater sleeve comprises a chemically etched layer of resistant metal.

16. The assembly of claim 11, wherein the heater sleeve comprises a seam coupling together opposite ends of the heater sleeve.

17. An internally heated valve assembly comprising:
a valve body comprising a bore;
first seat on a first end of the valve body;
a second seat on a second end of the valve body;
a ball positioned between and supported by the first seat and the second seat; and
a cylindrical heater sleeve that extends longitudinally between the first seat and the second seat, the heater sleeve configured to convert electrical energy into thermal energy, thereby heating fluid in the valve.

18. The assembly of claim 17, wherein the cylindrical heater sleeve is adhered to an inner surface of the bore.

19. The assembly of claim 17, wherein the heater sleeve comprises a passage that contains the ball, the first seat, and the second seat.

20. The assembly of claim 19, wherein the cylindrical heater sleeve further comprises one of a slit and a seam.
